(19) United States
(12) Patent Application Publication
(10) Pub. No.: US 2026/0192783 A1
(43) Pub. Date: Jul. 9, 2026

(54) METHODS FOR CHARGING AND REFUELING ELECTRIC VEHICLES WITH GASEOUS FUEL SYSTEMS

(71) Applicant: Ford Global Technologies, LLC, Dearborn, MI (US)

(72) Inventor: Dominique Meroux, Ann Arbor, MI (US)

(21) Appl. No.: 19/009,604

(22) Filed: Jan. 3, 2025

(51) Int. Cl. B60S 5/02; B60L 53/62; B60L 53/63

(52) U.S. Cl. CPC B60S 5/02; B60L 53/62; B60L 53/63

(57) ABSTRACT

Methods for a vehicle with a battery and a gaseous fuel tank are provided. In one example approach, a method comprises: adjusting a charge rate of the battery and a refueling rate of the gaseous fuel tank based on vehicle parameters, fuel station parameters, and target parameters; wherein the vehicle parameters comprise a pressure in the gaseous fuel tank, a vehicle ambient air temperature, and a state-of-charge of the battery; and wherein the fuel station parameters comprise gaseous fuel pressure capacities available at the fuel station, electric charging speeds available at the fuel station, and fuel station utilization information; and wherein the target parameters comprise a target gaseous fuel level, a target battery state-of-charge (SOC), and a time window to charge and refuel.

### FIELD

The present description relates to electric vehicles with gaseous fuel systems.

### BACKGROUND/SUMMARY

Disclosed herein are systems and methods for adjusting a charge rate of a battery and a refueling rate of a gaseous fuel tank based on vehicle parameters, fuel station parameters, and target parameters in order to reduce energy consumption during refueling events for a vehicle having an electric propulsion system and a gaseous fuel (e.g., hydrogen, natural gas, etc.) propulsion system. In one example approach, a method for a vehicle comprising an electric traction battery and a gaseous fuel tank is provided that comprises: adjusting a charge rate of the battery and a refueling rate of the gaseous fuel tank based on vehicle parameters, fuel station parameters, and target parameters; wherein the vehicle parameters comprise a pressure in the gaseous fuel tank, a vehicle ambient air temperature, and a state-of-charge (SOC) of the battery; and wherein the fuel station parameters comprise gaseous fuel pressure capacities available at the fuel station, electric charging speeds available at the fuel station, and fuel station utilization information; and wherein the target parameters comprise a target gaseous fuel level, a target battery state-of-charge, and a time window to charge and refuel.

In such an approach, a gaseous refueling speed and/or an electric charging speed may be selected and adjusted to affect energy losses during charging/refueling. For example, such an approach may reduce energy used for gas compression and temperature adjustments at various stages of refueling such as at-pump cooling, higher pressure storage bank replenishment, etc. In the approaches described herein, a charge rate for electrical charging may be slowed down to align with replenishing gaseous fuel, thereby potentially meeting targeted gaseous fuel fill and state-of-charge (SOC) levels within an available or targeted time window. Such an approach may reduce energy usage and infrastructure utilization, thereby potentially reducing resources, reducing CO₂ emissions, and potentially meeting emission targets.

The multi-energy approaches described herein may suited for fleet settings, where onboard storage of electricity and gaseous fuel may offer low-carbon propulsion, exportable power (gaseous fuel and electricity outlets) for a variety of job site equipment. Further, the approaches described herein may support a transition to substantially or approximately zero tailpipe emission operations while maximizing for efficiency and renewable energy pathways.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIGS. 1 and 2 show a schematic illustrations of example vehicles.

FIGS. 3A, 3B, and 3C shows example gaseous fuel refilling stations.

FIG. 4 shows an example method for refueling and charging an example vehicle.

FIG. 5 shows an example method for offsetting omissions.

FIG. 6 shows example utility factor curves.

FIG. 7 shows an example time-line of a vehicle refueling and recharging event.

### DETAILED DESCRIPTION

The following description relates to systems and methods for adjusting a charge rate of a battery and a refueling rate of a gaseous fuel tank based on various vehicle parameters, fuel station parameters, and target parameters in order to minimize energy consumption during refueling and recharging events for a vehicle having an electric propulsion system and a gaseous fuel energy source (e.g., hydrogen, natural gas, or any suitable combustible fuel in gaseous form).

As remarked above, multi-energy vehicles with secondary gaseous fuel propulsion systems or gaseous energy sources include plug-in hybrid electric vehicles (PHEVs) and extended-range electric vehicles (eREVs), or any suitable vehicle or machine having an electric battery power source combined with a gaseous fuel-driven power source. Gaseous fuel refill stations for such vehicles may provide compressed natural gas (CNG) and/or compressed hydrogen (or some other suitable gas) via on-site buffer storage tanks with different tiers of pressure (e.g., high, medium, low), for example. For example, a vehicle may receive fuel from increasing tiers of pressure as the gaseous fuel tank on-board the vehicle gets closer to full. Such refill stations may have differences in fill speeds offered, which may vary from fuel station to fuel station. In some examples, energy may be used to cool gaseous fuels upon delivery to a storage tank so that the gas will expand as it increases in temperature inside the gaseous fuel tank in a vehicle. Additionally, the fill pressure of gaseous fuels in a vehicle storage tank may be adjusted based on ambient temperatures or other environmental and/or operational factors. Such pressure and temperature adjustments for storing and refueling gaseous fuels may consume energy, which may lead to increased carbon dioxide (CO2) emissions and increased resources, for example.

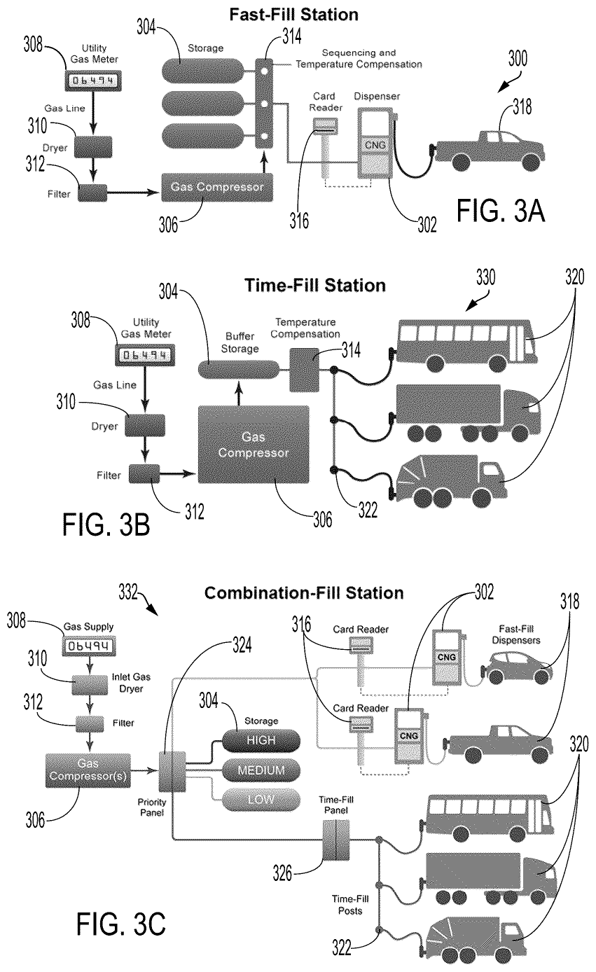

Gaseous fuels may have pressures of about 3,600 pound per square inch (PSI) for CNG and about 5,000 to 10,000 PSI for hydrogen in compressed form. In some examples, refueling infrastructure may include stations (also referred to herein as “fuel stations”) designated as “fast fill,” typically for faster refueling including public access stations. Another example type of station is a “time fill” station, which may be used in fleet depots as a lower-resource solution for applications like fleet vehicles that can refuel overnight, and where CNG can be delivered directly from a compressor rather than using on-site buffer storage as in the case of fast fill. “Combination fill” stations may include both “time fill” and “fast fill” options for greater flexibility. Time fill solutions may even include home refueling. As an example, compressed fuel from a home natural gas supply may be used for refueling. Examples of such stations are illustrated in FIGS. 3A, 3B, and 3C described below.

Gaseous fuel “fast fill” stations like compressed natural gas (CNG) and compressed hydrogen typically consist of on-site buffer storage tanks, for example with different tiers of pressure (e.g., high, medium, low) where a fast-filled vehicle receives fuel from increasing tiers of pressure as it gets closer to full; then the buffer storage may be replenished by again compressing gas to a target pressure for each tier. However, even fast fill stations may have differences in fill speeds offered. One strategy to increase fill speed for hydrogen is to cool hydrogen to about −40 degrees Celsius per SAE J2601 upon delivery to the storage tank, such that the gas will expand as it increases in temperature inside the gaseous fuel tank. In some examples, adjustments may be made to gaseous fuel fill amounts in a vehicle based ambient temperatures. For example, SAE J2601 provides an example on hydrogen refueling pressure mapping based on measured ambient air temperature.

In some examples, an “absorbed natural gas” (ANG) option may be implemented where fuel tanks have about 900 PSI pressure and use activated carbon storage tanks to hold the gas, such that the pressure and resources to refuel may be reduced relative to CNG, for example. The total amount of fuel may be lower in such a configuration. In such an approach, plug-in hybrid (PHEV) and extended range electric (eREV) solutions may use less stored gaseous fuel. Whether the configuration is ANG, CNG, or hydrogen, lower fuel storage may enable reduced gallon of gasoline equivalents (GGEs) of fuel that are to be transferred per unit of time.

The SAE J2601 protocol for hydrogen refueling provides examples for station processes, which includes a component that allows for sensor data communications between a hydrogen vehicle and the refueling station. Example sensor data communications are specified in SAE J279911. Specifically, SAE standards indicate the vehicle may provide signals including: tank volume, receptacle type (H35 or H70), fueling command, measured pressure, measured temperature, and optional data. Per SAE J2799, data may be transmitted between the vehicle and the refueling station via a data communications link, e.g., from an infrared (IR) transmitter on the vehicle to an IR receiver on a dispenser.

Gaseous fuel pathways may include renewables (such as landfill, food waste, agricultural waste-based methane) and “e-fuels” such as “eCNG.” While many gaseous fuel stations leverage credit systems to tie fossil fuel consumption to renewable generation that is injected into the pipeline elsewhere, some natural gas or hydrogen stations may have at least some share of on-site renewables generation.

The ability to achieve meaningful emissions reductions from these transitional vehicle types (such as PHEV and eREV) may involve outperforming in all-electric driving share of total vehicle miles, also known as “eVMT share” or equivalently, “utility factor” (UF). Here UF may be calculated as all-electric distance divided by total distance. What policymakers may want to avoid is a scenario where PHEVs and eREVs are heavily credited toward meeting zero emission vehicle (ZEV) targets, and these vehicles use electric vehicle (EV) driving less than expected. This can pose issues from a sustainability standpoint such as: missing transportation emissions reduction targets; and environmental effects from battery manufacturing, when combined with low battery usage, may lead to a lower-than-expected life-cycle emissions benefit, for example.

Some empirical studies show current-generation PHEVs are under-performing in all-electric share of total driving (eVMT, which is an interchangeable term with “utility factor,” UF), thus consuming more gasoline, and emitting more CO2 than expected. This is primarily due to charging behavior, for example the SAE J2841-based utility factor assumed PHEV drivers would charge daily to 100%.

Potential benefits may be achieved by aligning charging and gaseous refilling schedules as described herein: habit formation to plug in and connect the gaseous fuel connector at different ports but for the same event might be a behavioral mechanism to help reduce scenarios where only the gaseous fuel is used, which could lead to a low utility factor; and various smart charge strategies accounting for electricity consumed for both gaseous refilling and electric charging, as well as efficiency gains, might help reduce upstream emissions by maximizing grid electricity consumption at low-CO2 times, and demonstrate how this vehicle could be a transitional solution to full ZEV. Additional approaches described herein include providing ways to identify scenarios where charging did not occur but could have made a difference and allocate infrastructure funding to those locations.

The approaches described herein may provide adjustments to both a gaseous refueling speed and an electric charging speed to minimize energy losses during charging/refueling (e.g., to reduce energy for compression at various stages of gaseous fuel such as at-pump cooling, higher pressure storage bank replenishment, etc.). For example, a charge rate for electrical charging may be reduced (e.g., slowed down) to align replenishing gaseous fuel and electric charging so that targeted gaseous fuel fill and SOC levels are met within an available time window. The approaches described herein may be used to minimize energy consumption during refueling events and align timing of energy consumption for multi-energy vehicles with a secondary gaseous fuel propulsion system. Aligning charging and gaseous refilling may also be a way to reduce occurrences of scenarios like forgetting to plug in the vehicle, which may negatively affect all-electric share of driving (eVMT of total VMT, called “utility factor”) which has potential negative implications for credits attributable to PHEV & eREV.

Provided herein are systems and methods for a battery-powered plug-in vehicle (e.g., PHEV & eREV) with a secondary gaseous fuel propulsion system where a “go time” may be specified for when the vehicle will be used and a target charge SOC & fuel level is provided to be achieved by that time. Using the approaches described herein, gaseous refueling and electric charging speeds may be aligned to reach target values in a strategy to minimize energy losses and upstream environmental effects. In some examples, the vehicle may have one or both of a charging plug that could be plugged into one port and a gaseous fuel nozzle that could be plugged into a second port, where these may be done sequentially or in parallel if the station infrastructure allows.

In such an approach, both a gaseous refueling speed and an electric charging speed may be selected and adjusted to minimize energy losses during charging/refueling. For example, such an approach may reduce energy used for gas compression and temperature adjustments at various stages of refueling such as at-pump cooling, higher pressure storage bank replenishment, etc. In the approaches described herein, a charge rate for electrical charging may be aligned (slowed down or increased) with replenishing gaseous fuel, thereby potentially meeting targeted gaseous fuel fill and state-of-charge (SOC) levels within an available or targeted time window. One goal that may lead to slower charging (or even bi-directional power transfer) is a smart charging context where the vehicle has more time to charge and replenish the gaseous fuel than it needs to reach its target SOC. Where gaseous fuel dispensing has more time than required, it too can account for electricity consumption, on-site renewable gaseous fuel production, etc. to adjust whether to dispense and at what pressure(s).

On the other hand, the emissions-optimal strategy might be to increase charge speeds, for example in a case where the PHEV/eREV would otherwise not reach its target SOC. The motivation in this scenario is to maximize the utility factor (UF), i.e., share of distance in EV driving, and could include negotiation in price and time to get a utility-maximizing (in an economics sense) agreement. Example ways to increase charge speed may include: the charging station may opt to override the station's policy of de-rating at the EVSE the PHEV/eREV is plugged into; shift a greater proportion of shared power to the PHEV/eREV; and/or enable a station-level load balancing strategy to break its policy of allocated electricity to the EVSEs for this specific vehicle. As one example implementation, perhaps a driver of a CNG-PHEV is okay with taking 10 minutes instead of a default 5 minutes to add electricity & CNG in exchange for a lower CNG price, e.g., by taking 10 minutes, CNG refill pressures could be lower, and the driver may achieve a higher SOC (thus a higher UF). Such approaches may reduce energy usage and infrastructure utilization, thereby potentially reducing CO2 emissions, and potentially meeting emission targets.

The multi-energy approaches described herein may suited for fleet settings, where onboard storage of electricity and gaseous fuel may offer low-carbon propulsion, exportable power (gaseous fuel and electricity outlets) for a variety of job site equipment. Further, the approaches described herein may support a transition to substantially zero tailpipe emission operations while maximizing for efficiency and renewable energy pathways. Further, there may be opportunities to calculate benefits from strategies described herein, and/or calculate remaining emissions and environmental effects, then offset those in various ways. The approaches described herein may also serve to reduce strain on infrastructure and lack of availability, either to the fuel infrastructure itself or refueling pressures and charging speeds. In a fleet depot scenario, for example, priority may be dynamically provided to the vehicle about to begin its shift rather than sharing capacities with a vehicle that will be parked for the next 8 hours.

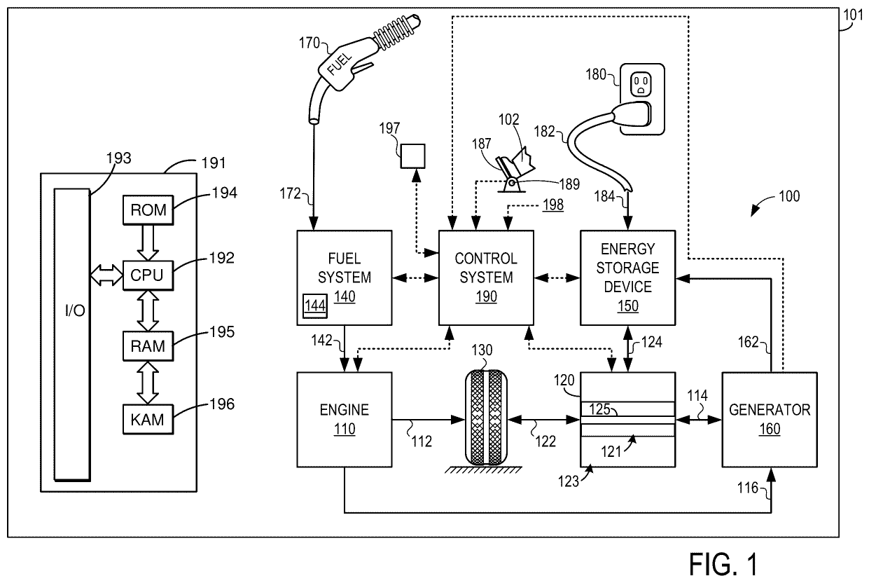

Turning now to the figures, FIGS. 1 & 2 show example vehicles having an electric propulsion system and a gaseous fuel propulsion system or onboard energy source. For the example the vehicles may comprise a PHEV or a eREV or some other type of vehicle that uses electricity from a battery stored onboard the vehicle and gaseous fuel from a gaseous fuel tank that is stored onboard the vehicle.

FIG. 1 illustrates an example vehicle propulsion system 100 in a vehicle 101. The vehicle propulsion system 100 includes a fuel burning engine 110 and an electric machine. As a non-limiting example, the engine 110 may be an internal combustion engine (ICE). Further, in a non-limiting example, the electric machine 120 may be a traction motor. The electric machine 120 includes a rotor assembly 121 and a stator assembly 123 that electromagnetically interact to generate rotational output. The rotor assembly 121 includes a rotor shaft 125 that is coupled to a downstream powertrain component.

Electric machine 120 is configured to utilize or consume a different energy source than engine 110. For example, engine 110 may consume a gaseous fuel (e.g., CNC, hydrogen, etc.) to produce an engine output while electric machine 120 consumes electrical energy to produce a motor output. As such, the vehicle 101 with the propulsion system 100 may be a hybrid electric vehicle (HEV). In such an example, as described in greater detail herein, the vehicle 101 includes an electric motor, a traction battery, and the like. In the hybrid vehicle example, the traction motor and the engine may have a variety of suitable architectures. However, in other examples, the vehicle may be an ICE vehicle. In other examples, the vehicle 101 may be an all-electric vehicle where the powertrain solely includes the traction motor as the propulsion source.

Vehicle propulsion system 100 may utilize a variety of different operational modes depending on operating conditions encountered by the vehicle propulsion system. Some of these modes may enable the engine 110 to be maintained in an off state (e.g., set to a deactivated state) where combustion of fuel at the engine is discontinued. For example, under select operating conditions, the electric machine 120 may propel the vehicle via the drive wheel 130 as indicated by arrow 122 while engine 110 is deactivated.

During other operating conditions, the engine 110 may be set to a deactivated state (as described above) while the electric machine 120 may be operated to charge the energy storage device 150. For example, the electric machine 120 may receive wheel torque from drive wheel 130 as indicated by arrow 122 where the motor may convert the kinetic energy of the vehicle to electrical energy for storage at the energy storage device 150 as indicated by arrow 124. This operation may be referred to as regenerative speed reduction of the vehicle. Thus, the electric machine 120 can provide a generator function in some embodiments. However, in other embodiments, a generator 160 may instead receive wheel torque from the drive wheel 130, where the generator may convert the kinetic energy of the vehicle to electrical energy for storage at the energy storage device 150 as indicated by arrow 162.

During still other operating conditions, the engine 110 may be operated by combusting fuel received from a fuel system 140 as indicated by arrow 142. For example, the engine 110 may be operated to propel the vehicle via drive wheel 130 as indicated by arrow 112 while the electric machine 120 is deactivated. During other operating conditions, both the engine 110 and the electric machine 120 may each be operated to propel the vehicle via drive wheel 130 as indicated by arrows 112 and 122, respectively. A configuration where both the engine and the motor may selectively propel the vehicle may be referred to as a parallel type vehicle propulsion system. Note that in some embodiments, the electric machine 120 may propel the vehicle via a first set of drive wheels and the engine 110 may propel the vehicle via a second set of drive wheels.

In other embodiments, vehicle propulsion system 100 may be configured as a series type vehicle propulsion system, whereby the engine does not directly propel the drive wheels. Rather, the engine 110 may be operated to power the electric machine 120, which may in turn propel the vehicle via drive wheel 130 as indicated by arrow 122. For example, during select operating conditions, the engine 110 may drive the generator 160 as indicated by arrow 116, which may in turn supply electrical energy to one or more of the electric machine 120 as indicated by arrow 114 or energy storage device 150 (e.g., a battery) as indicated by arrow 162. As another example, the engine 110 may be operated to drive the electric machine 120 which may in turn provide a generator function to convert the engine output to electrical energy, where the electrical energy may be stored at energy storage device 150 for later use by the motor.

The fuel system 140 may include one or more fuel storage tanks 144 for storing fuel on-board the vehicle. For example, the fuel tank(s) 144 may store one or more gaseous fuels, including but not limited to: natural gas or hydrogen. The fuels in strange tanks 144 may be delivered to the engine 110 as indicated by arrow 142, where they may be combusted at the engine to produce an engine output. The engine output may be utilized to propel the vehicle as indicated by arrow 112 or to recharge the energy storage device 150 via the electric machine 120 and/or the generator 160. The engine 110 and the other engines described herein may be configured for compression and/or spark ignition, for example.

In some embodiments, the energy storage device 150 may be configured to store electrical energy that may be supplied to other electrical loads residing on-board the vehicle (other than the motor), including cabin heating and air conditioning, engine starting, headlights, cabin audio and video systems, etc. As a non-limiting example, the energy storage device 150 may include one or more batteries and/or capacitors.

Control system 190 may communicate with one or more of the engine 110, the electric machine 120, the fuel system 140, the energy storage device 150, and the generator 160. Control system 190 may receive sensory feedback information from one or more of the engine 110, the electric machine 120, the fuel system 140, the energy storage device 150, and the generator 160. Further, control system 190 may send control signals to one or more of the engine 110, the electric machine 120, the fuel system 140, the energy storage device 150, and the generator 160 responsive to this sensory feedback. Additionally, control system 190 may be configured to send and receive sensory feedback to/from a station or refueling and/or electric charging apparatus. The control system 190 may receive an indication of an operator requested output of the vehicle propulsion system from a vehicle operator 102. For example, the control system 190 may receive sensory feedback from a pedal position sensor 189 which communicates with a pedal 187. The pedal 187 may refer schematically to a speed adjustment pedal.

The control system 190 includes a controller 191. The controller 191 is shown in FIG. 1 as a conventional microcomputer including: microprocessor unit 192, input/output ports 193, read-only memory 194 (e.g., non-transitory memory), random access memory 195, keep alive memory 196, and a conventional data bus. Controller 191 is shown receiving various signals from sensors coupled to engine 110, in addition to those signals previously discussed, including: engine coolant temperature (ECT) from temperature sensor coupled to a cooling sleeve; a position sensor coupled to an driver demand pedal for sensing force applied by human foot; a position sensor coupled to caliper control pedal for sensing force applied by foot, a measurement of engine manifold pressure (MAP) from pressure sensor coupled to intake manifold; an engine position sensor from a position sensor sensing crankshaft position; a measurement of air mass entering the engine from sensor; and a measurement of throttle position from a sensor. Barometric pressure may also be sensed for processing by controller 191. A position sensor may produce a predetermined number of equally spaced pulses each revolution of the crankshaft from which engine speed (RPM) can be determined.

The controller 191 may receive various signals from sensors coupled to the engine 110, including measurement of manifold airflow pressure (MAP) sensor; engine coolant temperature (ECT) from temperature sensor exhaust gas air/fuel ratio from exhaust gas sensor; a crankcase pressure sensor (CKCP); BP sensor, TIP sensor, etc. Furthermore, the controller may monitor and adjust the position of various actuators based on input received from the various sensors. These actuators may include, for example, the throttle, and intake and exhaust valve systems. Storage medium read-only memory 194 can be programmed with computer readable data representing instructions executable by processor 192 for performing the methods described below, as well as other variants that are anticipated but not specifically listed.

During operation, each cylinder within engine 110 typically undergoes a four stroke cycle: the cycle includes the intake stroke, compression stroke, expansion stroke, and exhaust stroke. During the intake stroke, generally, the exhaust valve closes and intake valve opens. Air is introduced into combustion chamber via intake manifold, and piston moves to the bottom of the cylinder so as to increase the volume within combustion chamber. The position at which piston is near the bottom of the cylinder and at the end of its stroke (e.g., when combustion chamber is at its largest volume) is typically referred to by those of skill in the art as bottom dead center (BDC). During the compression stroke, the intake valve and the exhaust valve are closed. The piston moves toward the cylinder head so as to compress the air within the combustion chamber. The point at which the piston is at the end of its stroke and closest to the cylinder head (e.g. when the combustion chamber is at its smallest volume) is typically referred to by those of skill in the art as top dead center (TDC). In a process hereinafter referred to as injection, fuel is introduced into the combustion chamber. In a process hereinafter referred to as ignition, the injected fuel is ignited by known ignition means such as a spark plug and/or compression ignition, resulting in combustion.

During the expansion stroke, the expanding gases push the piston back to BDC. Crankshaft converts piston movement into a rotational torque of the rotary shaft. Finally, during the exhaust stroke, the exhaust valve opens to release the combusted air-fuel mixture to the exhaust manifold and the piston returns to TDC. Note that the above is shown merely as an example, and that intake and exhaust valve opening and/or closing timings may vary, such as to provide positive or negative valve overlap, late intake valve closing, or various other examples.

The energy storage device 150 may periodically receive electrical energy from a power source 180 residing external to the vehicle (e.g., not part of the vehicle) as indicated by arrow 184. As a non-limiting example, vehicle propulsion system 100 may be configured as a plug-in HEV, whereby electrical energy may be supplied to energy storage device 150 from the power source 180 via an electrical energy transmission cable 182. During a recharging operation of the energy storage device 150 from the power source 180, the electrical transmission cable 182 may electrically couple the energy storage device 150 and the power source 180. While the vehicle propulsion system 100 is operated to propel the vehicle, electrical transmission cable 182 may be disconnected between the power source 180 and the energy storage device 150. The control system 190 may identify and/or control the amount of electrical energy stored at the energy storage device, which may be referred to as the state of charge (SOC).

In other embodiments, the electrical transmission cable 182 may be omitted, where electrical energy may be received wirelessly at the energy storage device 150 from the power source 180. For example, the energy storage device 150 may receive electrical energy from the power source 180 via one or more of electromagnetic induction, radio waves, and electromagnetic resonance. As such, it should be appreciated that any suitable approach may be used for recharging energy storage device 150 from a power source that does not comprise part of the vehicle, such as from solar or wind energy. In this way, the electric machine 120 may propel the vehicle by utilizing an energy source other than the fuel utilized by the engine 110.

The fuel system 140 may periodically receive fuel from a fuel source residing external to the vehicle. As a non-limiting example, the vehicle propulsion system 100 may be refueled by receiving fuel via a fuel dispensing device 170 as indicated by arrow 172. In some embodiments, fuel tank 144 may be configured to store the fuel received from the fuel dispensing device 170 until it is supplied to the engine 110 for combustion. In some embodiments, control system 190 may receive an indication of the level of fuel stored at the fuel tank 144 via a fuel level sensor. The level of fuel stored at the fuel tank 144 (e.g., as identified by the fuel level sensor, which may correspond to a pressure sensor in the case of a gaseous fuel) may be communicated to the vehicle operator 102, for example, via a fuel gauge or indication in a vehicle instrument panel 197.

The vehicle propulsion system 100 may also include an ambient temperature/humidity sensor 198, and the like. The vehicle instrument panel 197 may include indicator light(s) and/or a text-based display in which messages are displayed to an operator. The vehicle instrument panel 197 may also include various input portions for receiving an operator input, such as buttons, touch screens, voice input/recognition, etc.

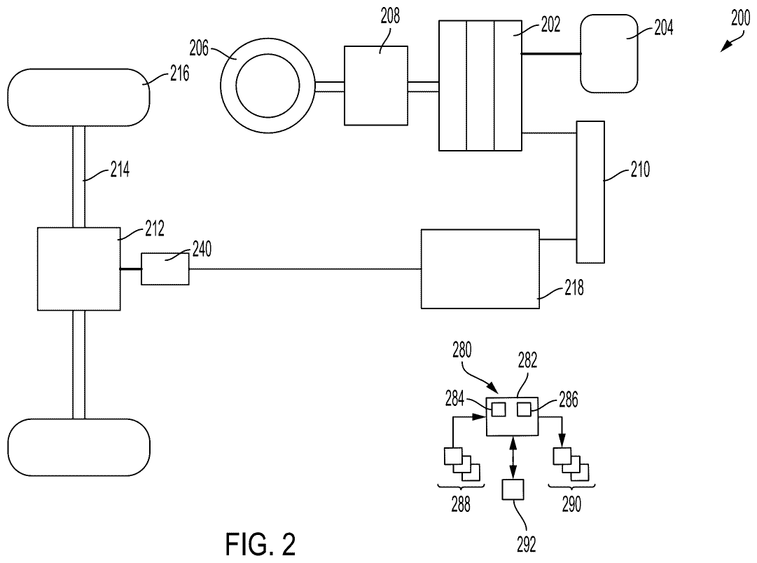

FIG. 2 shows a schematic depiction of an example fuel cell electric vehicle system 200. The system 200 comprises a fuel cell or fuel cell stack 202. The fuel cell may comprise one or more electrochemical cells that convert the chemical energy of a fuel, e.g., hydrogen, and an oxidizing agent, e.g., oxygen, into electricity via redox reactions. Fuel cells may be different from most batteries in that they may use a source of fuel and oxygen (usually from air) to sustain the chemical reaction, whereas in a battery the chemical energy usually comes from substances that are already present in the battery. Fuel cells can produce electricity as long as fuel and oxygen are supplied.

As a nonlimiting example, fuel cell 202 may be a polymer electrolyte membrane (PEM) fuel cell. In a PEM fuel cell, an electrolyte membrane is sandwiched between a positive electrode (cathode) and a negative electrode (anode), so that the fuel cell 202 has multiple layers in a stack. Hydrogen is introduced to the anode, and oxygen (from air) is introduced to the cathode. The hydrogen molecules break apart into protons and electrons due to an electrochemical reaction in a fuel cell catalyst in the fuel cell. Protons then travel through the membrane to the cathode and electrons may then travel through a circuit in system 200 to perform work, such as providing power to various components in system 200, then recombine with the protons on the cathode side where the protons, electrons, and oxygen molecules combine to form water. The chemical reaction that creates energy in the fuel cell is the same as burning hydrogen with oxygen to create H₂O (water). This electrochemical method used in fuel cells is very efficient and fuel cells are much lighter than large batteries that are often used.

In order to supply hydrogen to the fuel cell 202, system 200 may include a hydrogen source 204. For example, hydrogen source 204 may comprise one or more hydrogen storage tanks located onboard the vehicle that can be refilled. The hydrogen source 204 may be fluidically coupled to fuel cell 202 to provide hydrogen to the fuel call and the connection between the hydrogen source and the fuel cell may include various other components (not shown), such as one or more valves to control hydrogen flow, injectors to inject hydrogen into the fuel cell layers, and various other components.

In addition to the fuel cell stack and the hydrogen tanks, system 200 may include an air compressor 206 (or other suitable air intake device or system) to supply air to the fuel cell 202. In some examples, the compressor can be controlled to provide a target amount of air, including oxygen, at a desired pressure through layers in the fuel cell stack so that the reaction between hydrogen (H₂) and oxygen (O₂) can take place at a desired ratio in the fuel cell to generate electricity. The air compressor may be any suitable type of compressor including but not limited to: a roots, scroll, or screw compressor, which may operate at around 10-14 k rpm, or a high centrifugal compressor, which may operate at around 90-150 k rpm. The air compressor 206 may include various components such as an air intake to capture environmental air, one or more air filters to filter the intake air and other components (not shown). For example, system 200 may include a bypass/load control element in a compressor air handler, bypass valves for controlling air flow into, through and out of the compressor, back pressure valves for flow control, etc.

The air compressor 206 may be fluidically coupled to the fuel cell to provide oxygen to the fuel cell. The connection between the compressor 206 and fuel cell 202 may include various components 208 such as air coolers, humidifiers etc. Excess air from the compressor and water may be output from the fuel cell, therefore system 200 may include one or more water separators to separate air from water output from the fuel cell. The water output by the fuel cell may be delivered to other system components or output to the environment and the air output by the fuel cell may be directed back into the compressor, into other components of the system, or output to the environment.

System 200 may further comprise one or more batteries to store electricity generated by the fuel cell or other system components. For example, battery 210 may be electronically coupled to fuel cell 202 and configured to receive power generated by the fuel cell. Battery 210 may be electronically coupled to various components in system 200 to provide power to the components during certain conditions. For example, battery 210 may be coupled to motor system 218 described below. Battery 210 may also be connected to compressor 206 in some examples. In some examples, as described above with regard to FIG. 1, the battery 210 may periodically receive electrical energy from a power source residing external to the vehicle (e.g., not part of the vehicle).

System 200 further comprises an electric motor 218 that is configured to be powered by the battery 210. In some examples, motor 218 may also be powered directly by the fuel cell 202 during some operational modes. In some examples, motor 218 may include an inverter for controlling the speed and/or torque of the motor. In some examples, the electric motor 218 may be mechanically coupled via a transmission to a driveshaft of the vehicle. In this way, the motor 218 may be used to provide power to turn the wheels 216 of a vehicle via an axle 214 and traction device 212 to drive the vehicle. As used herein, the term “driveshaft” is intended to mean any suitable component for transmitting mechanical power, torque, and/or rotation, usually used to connect other components of a drivetrain of a vehicle.

As in FIG. 1, described above, system 200 may also include a control system 280 with a controller 282. The controller 282 may include a processor 284 and memory 286. The memory 286 may hold instructions stored therein that when executed by the processor cause the controller 282 to perform the various methods, control techniques, and the like, described herein. The processor 284 may include a microprocessor unit and/or other types of circuits. The memory 286 may include known data storage mediums such as random access memory, read only memory, keep alive memory, combinations thereof, and the like.

The controller 282 may receive various signals from sensors 288 positioned in different locations in the system 200. The sensors may include speed sensors, energy storage device temperature sensor(s), an energy storage device state of charge sensor(s), fuel tank pressure sensors (to measure gaseous fuel level in tank 204), ambient temperature sensors, wheel speed sensors, and the like. The controller 282 may also send control signals to various actuators 290 coupled at different locations in the system 200. System 200 may also include one or more input device(s) 292 (e.g., a drive pedal, a caliper pedal, a console instrument panel, a touch interface, a touch panel, a keyboard, combinations thereof, and the like). The input device(s) 292, responsive to driver input, may generate a vehicle drive torque adjustment request, for example.

FIGS. 3A, 3B, and 3C shows example gaseous fuel refilling stations. The examples shown in FIGS. 3A, 3B, and 3C show three example types of CNG infrastructures, including fast-fill (illustrated in FIG. 3A), time-fill (illustrated in FIG. 3B) and a combination of the two (illustrated in FIG. 3C). Hydrogen or other gaseous fuel stations may have infrastructure similar to the examples shown in these figures. The main structural differences between fast-fill and time-fill systems may be the amount of storage capacity available and the size of the compressor(s). These factors may determine the amount of fuel dispensed and the time it takes for CNG (or some other gaseous fuel) to be delivered. Most CNG stations include one of these two system types, but the third combination fill station type includes both systems (illustrated in FIG. 3C).

FIG. 3A shows an example fast-fill station 300. Fast-fill station 300 comprises a utility gas meter 308 connected via a gas line to a dryer 310 and a filter 312 through which gaseous fuel passes before being delivered into a gas compressor 306. From gas compressor 306, the gaseous fuel may be delivered into a sequencing and temperature compensation element 314, which may adjust temperature of the gaseous fuel and determine at what pressure and which storage tank is to be used, before being stored in storage devices 304. The gaseous fuel may be delivered to a vehicle 318 via a dispenser 302. In some examples, there may be a card reader 316 (or other suitable payment system) to accept payment upon refueling.

Fast-fill stations may be suited for retail situations where vehicles arrive randomly and want to refuel quickly. For example, many public CNG stations may have a fast-fill option. In some examples, fast-fill stations may receive fuel from a local utility line at a low pressure and then use a compressor on-site to compress the gas to a high pressure. Once compressed, the CNG may be delivered to a series of storage vessels so the fuel is available for a quick fill-up. CNG at fast-fill stations may be stored in the vessels at a high service pressure (e.g., 4,300 psi) so the dispenser can deliver it to a vehicle quickly. The dispenser may use sensors to calculate pressure and measure the number of gasoline gallon equivalents (GGEs) delivered to the tank, taking temperature into account. CNG can also be delivered via dispensers alongside gasoline or other fuels and electric charging stations or ports.

FIG. 3B shows an example time-fill station 330. Time-fill station 330 comprises a utility gas meter 308 connected via a gas line to a dryer 310 and a filter 312 through which gaseous fuel passes before being delivered into a gas compressor 306. From gas compressor 306 the gaseous fuel may be delivered into a buffer storage device 304. The gaseous fuel may pass through a temperature compensation system 314, which may be configured to adjust the temperature of the gaseous fuel, before being delivered to vehicles 320 via time-fill posts or line 322.

Time-fill stations may be used primarily by fleets and/or for vehicles with large tanks that refuel at a central location every night. At a time-fill station, a fuel line from a utility may deliver natural gas at a low pressure to a compressor on-site. Unlike fast-fill stations, vehicles at time-fill stations may be filled directly from the compressor, not from fuel stored in high pressure vessels. The size of the compressor used may depend on the number of vehicles to be fueled. Although there may be a small buffer storage tank, its purpose may not be to fill vehicles but to keep the compressor from cycling off and on unnecessarily, thereby wasting electricity and causing undue wear and tear on the compressor. The storage tank may sometimes be used to “top off” vehicle tanks during the day.

The time it takes to fuel a vehicle may depend on the number of vehicles, compressor size, and the amount of buffer storage. Vehicles may take several minutes to many hours to fill. The advantage of using a time-fill station is that the heat of compression may be less, and this results in a fuller fill than a fast-fill station can provide. Another advantage is that a fleet manager can control when the vehicles are filled, such as during off-peak hours (like at night) when electricity rates are lower.

Time-fill stations may be carefully architected based on the intended use. For example, a transit bus company may use a larger compressor that can deliver 8 to 9 gallons per minute, while a refuse truck company can make do filling trucks at 3 gallons per minute using a smaller compressor. A consumer application may use far less, e.g., less than a gallon per hour. These differences may account for the large variance in the resources of installation.

FIG. 3C shows an example combination-fill station 332, which combines features of fast-fill station 300 with time-fill station 330. Combination-fill station 332 comprises a utility gas meter 308 connected via a gas line to an inlet gas dryer 310 and a filter 312 through which gaseous fuel passes before being delivered into a gas compressor 306. From gas compressor 306, the gaseous fuel may be delivered through a priority panel 324, which determines what pressure and what tank to store the gaseous fuel in, into a tiered storage system 304 (e.g., a high pressure tank, a medium pressure tank and a low pressure tank). For fast-fill delivery to vehicles 318, the gaseous fuel may be delivered via dispensers 302. For time-fill delivery to vehicles 320, the gaseous fuel may pass through a time-fill panel 326, which may determine refuel timing, and delivered to vehicles 320 via time-fill posts or line 322.

As remarked above, combination-fill stations may include both time-fill and fast-fill options for greater flexibility. Combination-fill stations may include both the fast-fill and time-fill components in one system. The vehicles connected to the time-fill posts may be filled directly from the compressor, usually overnight. Vehicles at the fast-fill dispensers may be filled from the storage vessels or from the compressor, depending upon circumstances. The combination-fill design may provide a fleet with flexibility. Combination-fill stations typically are more resource intensive to build than the time-fill and fast-fill stations. A combination-fill station can also be a revenue source if the fast-fill dispensers are made available to the public.

For hydrogen (and other gaseous fuel) stations, fuel station infrastructure may be similar to those shown in FIGS. 3A, 3B, and 3C. In some examples, there may be hydrogen production equipment on-site at the station (or delivered to the station) and then the gas may be compressed via a pneumatic compressor that equalizes pressures between storage tanks and the vehicle(s). Before delivery to a vehicle, the compressed hydrogen may be stored in a hydrogen storage system. In some examples, before delivery via a dispenser to a vehicle, the hydrogen may be cooled so that the gas will expand as it increases in temperature inside the gaseous fuel tank in the vehicle.

The fuel stations described above may additionally include charging stations or charging systems, for recharging batteries while also refueling gaseous fuel tanks in a vehicle. In some examples, electric ports may be included in a gaseous fuel dispenser (or some other suitable location at the station) so that a vehicle can recharge its onboard battery while simultaneously refueling an onboard gaseous fuel tank. The stations may additionally include various sensors and electronic communication protocols to detect, connect with, and share data between the station and the vehicles that are being refueled and/or recharged.

FIGS. 1, 2, 3A, 3B, and 3C may be shown approximately to scale. However, the components may have other relative dimensions, in alternate embodiments. FIGS. 1, 2, 3A, 3B, and 3C show example configurations with relative positioning of the various components. Unless otherwise noted, if shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example.

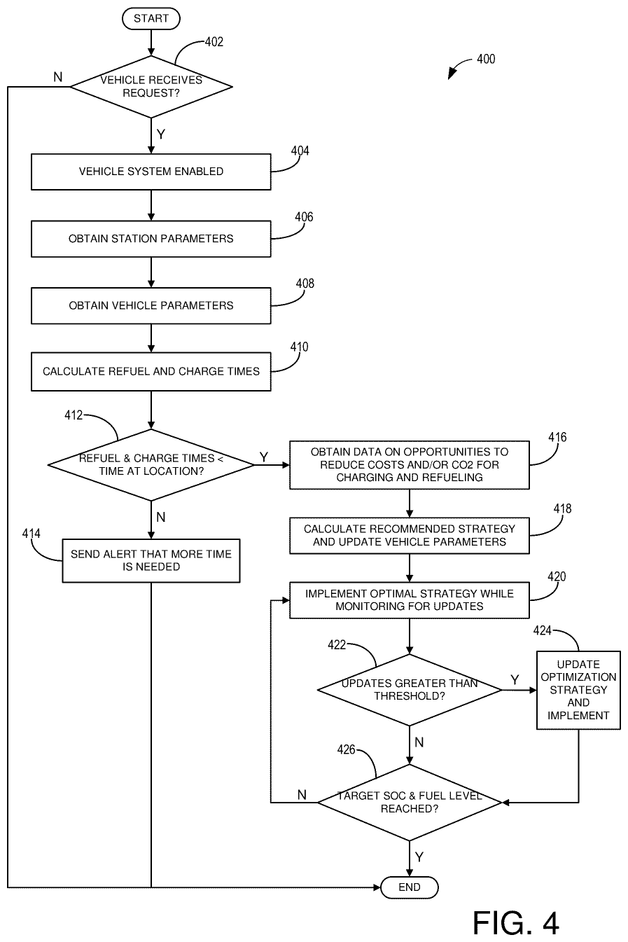

FIG. 4 shows an example method 400 for refueling and charging an example vehicle, such as the vehicles described above with respect to FIGS. 1 and 2. For example, method 400 may be used for refueling and/or recharging a plug-in hybrid electric vehicle (PHEV), an extended-range electric vehicle (eREV), or some other suitable vehicle or machine having an onboard rechargeable battery and an onboard gaseous fuel tank. In particular, method 400 provides example approaches for adjusting a charge rate of a battery and a refueling rate of a gaseous fuel tank based on various vehicle parameters, fuel station parameters, and target parameters in order to minimize energy consumption during refueling and recharging events for a vehicle having an electric propulsion system and a gaseous fuel energy source (e.g., hydrogen, natural gas, or any suitable combustible fuel in gaseous form) stored onboard the vehicle in a gaseous fuel tank. For example, the gaseous fuel tank may comprise a compressed natural gas (CNC) fuel tank, a hydrogen fuel tank, or a fuel tank configured to hold some other suitable gaseous fuel. As used herein the term “gaseous fuel” may be taken to mean any suitable fuel that is stored in gaseous form in a storage device, such as a storage tank or the like, for use as a fuel.

At 402, method 400 includes determining if a vehicle receives a request for refueling a gaseous fuel tank onboard a vehicle and/or recharging a battery onboard the vehicle. Determining if the vehicle received a request may be performed in response to a user or driver initiated input into an interface at a fuel station and/or an input to a vehicle system. As another example, a request may be received via fleet management software or some other suitable software residing on a computing device at a fuel station and/or in a vehicle or on an external server or computing device in communication with the station and/or vehicle. As another example, determining if a request is received may be performed in response to sensor data received and/or sent via sensors coupled to a fuel tank, a battery system, and/or on components at a fuel station, e.g., at a fuel dispenser or charging station. As another example, a request may be based on a current state-of-charge (SOC) of an onboard battery in the vehicle being less than a predetermined threshold and/or a fuel level (e.g., measured as pressure for gaseous fuels) being less than a predetermined threshold. In some examples, such a request may include a user input of a target gaseous fuel level, a target charge event SOC and/or an expected time window.

For example, a “go time” may be specified for when the vehicle will be used and a target charge SOC & fuel levels to be achieved by that time. Gaseous refueling and electric charging speeds may be aligned to reach target values in a strategy to minimize energy losses, and upstream environmental effects categories. In some examples, the vehicle may have one or both of a charging plug that could be plugged into one port and a gaseous fuel nozzle that could be plugged into a second port, where these may be done sequentially or in parallel if the station infrastructure allows.

If the vehicle receives a request at 402, for example from a customer in-vehicle or via fleet management software or the like, that contains a target gaseous fuel level, a target charge event end state of charge (SOC), and an expected time window within which each can be accomplished, then method 400 proceeds to 404 to enable the vehicle system so that the vehicle system is readied to obtain various parameters.

At 406, method 400 includes obtaining station parameters. For example, the system may attempt to obtain various station parameters either from an existing database or from communication with the planned refueling station, for example via exchange between a telematics modem or other wireless protocol, and/or using vehicle sensors if the vehicle is on-site. Examples of station parameters that may be obtained include: gaseous fuel station default pressure capacities, which may be shared ahead of time from the station or shared by other vehicles but certainly available via connection with the fuel nozzle per SAE J2799; electric charging speed(s) available from the electric vehicle supply equipment (EVSE(s)), which may be shared ahead of time from the station or shared by other vehicles but certainly available once plugged in; any queueing and utilization schedule (if one exists, for example in a fleet depot scenario) or forecast (if one exists, for example at a public access station, while the event is upcoming or updated as vehicles arrive at the station. For example, the station may suddenly see more vehicles arrive than expected, leading to an update to the forecast) and utilization status (status when the vehicle is at the station).

Examples of fuel station parameters that may be obtained include: gaseous fuel station pressure capacities, electric charging speed(s) available from EVSE(s), and/or queuing or utilization information. For example, the fuel station parameters may comprise one or more of gaseous fuel pressure capacities available at the fuel station; electric charging speeds available at the fuel station; and fuel station utilization information. If possible, open communication with the station to coordinate strategies in subsequent steps may be performed.

At 408, method 400 includes obtaining vehicle parameters. Examples of vehicle parameters that may be obtained include: vehicle gaseous fuel level, tank pressure, ambient air temperature, vehicle high voltage battery SOC, and/or vehicle limitations. For example, the vehicle parameters may comprise one or more of a gaseous fuel level in the gaseous fuel tank. a pressure in the gaseous fuel tank, a vehicle ambient air temperature and/or a state-of-charge of the battery.

In some examples, the vehicle and station may coordinate for a resource minimization strategy. For example, a fleet depot may want to lower resources, while a public charging station might offer a lower fuel price to split energy savings, for example. Another benefit to both parties might be dynamic allocation of higher pressure and charge power to other vehicles that use this. For example, if a fleet vehicle ended its day and another truck is about to start its route, then infrastructure optimization may be implemented.

At 410, method 400 includes calculating refuel and charge times. For example, calculations may be performed to estimate refuel (gaseous fuel) and charge (electric charging) times to reach a target in a default scenario, given limitations. Examples of vehicle sensor data that may be input into the system for calculations include: vehicle gaseous fuel level, tank pressure, ambient air temperature, vehicle high voltage battery SOC and/or vehicle limitations on gaseous fuel pressure and EV charging current and voltage for AC and/or DC fast charging, with a forecast that updates, if the refueling and charge event is upcoming rather than about to occur, for example.

Given input values from the vehicle request and from (or about) the station and from (or about) the vehicle, the vehicle may calculate estimated refuel (gaseous fuel) and charge (electric charging) times to reach targets. For example, the calculations may determine how much to adjust refueling and charging rates. For example, for gaseous fuels, energy consumption used may be reduced during refilling in a variety of ways. In one example, energy consumption may be reduced through vehicle acceptance of a slower fill than what is available from the refueling station, for example to reduce energy for compression at various stages such as at-pump cooling (e.g., hydrogen is typically cooled to up to −40 degrees Celsius before delivery to the vehicle), switching to and replenishing a higher pressure storage bank, etc. Especially in slower-fill scenarios like home or depot overnight, refueling timing and stages may be aligned (and their associated energy usage) with smart charge strategies, such that energy consumption is shifted to lower-resource and lower-CO2 times where possible. Accounting for losses in any bi-directional transfer and exportable power, both energy consumption for gaseous fuel compression and energy draw for electric vehicle (EV) charging may be optimized to when and how much grid energy is consumed, for example. For electric charging, AC or DC charge power may be accepted from the EV charger at a level and/or rate that is less than what is available from the charger (and less than a maximum that the vehicle can accept) per a user-designated preference, for example. Where possible, “go times” may be aligned between replenishing gaseous fuel and electric charging.

At 412, method 400 includes determining if refuel and charge times are less than a time that the vehicle is or can be at the station location for charging and/or refueling. For example, it may be determined that default refuel and charge times may be less than a planned time at the station location. If refuel and charge times are not less than time at location at 412, then method 400 proceeds to 414 to send an alert that more time is needed. For example, a driver or fleet software may be alerted or notified that more time is needed to reach a target fuel level and/or target SOC. However, if at 412, refuel and charge times are less than time at location then method 400 proceeds to 416.

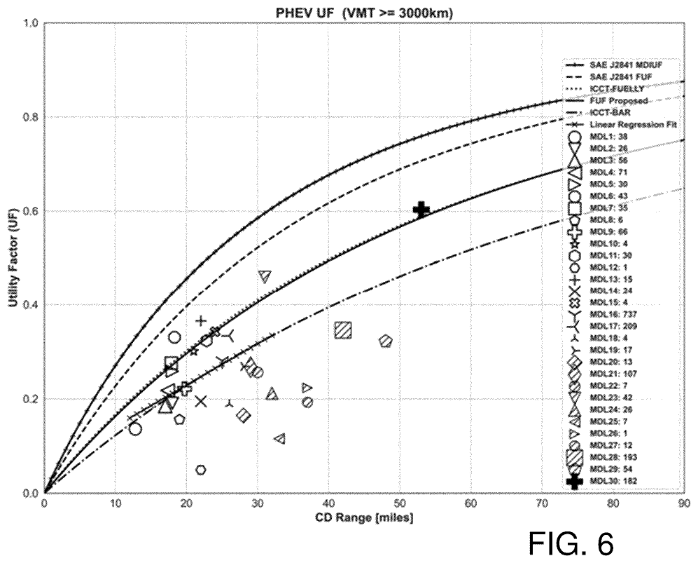

At 416, method 400 includes obtaining data on opportunities to reduce CO2 for charging and refueling. In particular, data may be obtained on opportunities to reduce resources and/or CO2 for charging and gaseous fuel refueling, such as lower-resource and lower-CO2 and/or higher renewables share. This may include calculating a recommended strategy and updating vehicle parameters accordingly, such as requested charge current and voltage following an optimized charge curve, and requested gaseous fuel pressure following the gaseous fuel curve (such as the curves shown in FIG. 6). If the vehicle has more available time to meet targeted gaseous fuel fill and SOC levels beyond what is used to meet the targets, and infrastructure availability indicates it is not at capacity (e.g., more gaseous fuel pumps and plugs than taken or forecast/scheduled to be taken), then method 400 may proceed to the next step.

At 418, method 400 includes calculating a recommended strategy and updating vehicle parameters based on capacities and opportunities to reduce resources and CO2 emissions. For example, for electricity, optimal charge times may be calculated and associated power levels in a smart charge strategy may be implemented. During the charge event, charge power levels may be reduced to anywhere between negative (bi-directional transfer and/or exportable power) and the minimum of station and vehicle capacities according to an optimal charge curve. For example, grid energy consumption may be considered for gaseous fuel compression & electric charging. If there are opportunities to support a stage in compression and add back charge later, such that even after accounting for losses in bi-directional power transfer the action may result in a net reduction in resource & CO2, then this strategy may be a part of the charge curve. For gaseous fuel, optimal times to engage refilling and associated pressure ramp-up curves may be calculated. The following approach suggests how this may be implemented with modifications to a SAE J2601 and J2799 hydrogen refilling & data protocol, but implementation may leverage different communications protocols and messages. If the refueling nozzle is connected outside of optimal refueling times, the protocol may include acknowledging time for checks in the refueling process. For example, refueling may be paused until the desired start time or refueling may be aborted. If the refueling event is slow-fill and the time window it takes place in can be shifted, refueling may be paused for a relatively longer duration. For example, a public access station with low occupancy at a given time of day may align charging and refill schedules to take place over 30 minutes (instead of 5 minutes at full refill speeds, for example), while a depot slow fill scenario may take place over 4 hours, so this could be shifted from 5 pm-9 pm to midnight-4 am, for example.

For the slow fill scenario, electricity consumption at each stage may be considered for the compressor and event milestones including when to start refueling with lower-resource and lower-CO2 times, and then aligned with a smart charge strategy. Faster fill may enable different strategies to align timing with energy consumption, such as alternate refueling and charge times of day. For example, fleet management software may indicate that grid solar energy is available at low resources when a truck is typically parked for lunch, representing a good opportunity to plug in and connect the gaseous fuel nozzle, instead of refilling at the end of the shift at 5 pm, for example. During refueling, pressure may be requested based on at least vehicle temperature and pressure status, a minimum of vehicle requested pressure, available station pressure, temperature-adjusted pressure, and maximum pressure from a lookup table, for example.

At 420, method 400 includes implementing an optimal refuel and charging strategy while monitoring for updates. For example, method 400 may include adjusting a charge rate of the battery and a refueling rate of the gaseous fuel tank based on vehicle parameters and fuel station parameters. In particular, the charge rate of the battery and the refueling rate of the gaseous fuel tank may be adjusted based on a target gaseous fuel level and a target battery state-of-charge. Additionally, the charge rate of the battery and the refueling rate of the gaseous fuel tank may be adjusted based on a time window to charge and refuel. In some examples, adjusting the charge rate of the battery may comprise charging the battery at a rate less than what is available from an electric charger at the fuel station.

This optimal charging and refuel strategy may be carried out while the system listens for updates from the station infrastructure and dynamically re-optimizing in response to changes. For example, updates to infrastructure utilization may be monitored and, if anything changes beyond a threshold, the optimal strategy may be updated or reverted to a default strategy of max refueling pressure and charge speeds, for example. Thus method 400 may include monitoring fuel station capacity utilization and updating the charge rate of the battery and the refueling rate of the gaseous fuel tank in response to a change in fuel station capacity utilization. Monitoring station capacity utilization may be used to ensure the optimization does not lead to wait times for other users, and to update the control strategy as applicable, up to reverting to default charge and fuel curves if infrastructure availability unexpectedly becomes a constraint, for example.

At 422, method 400 includes determining if updates are greater than a threshold. If updates are greater than a threshold at 422, method 400 proceeds to 424. At 424, method 400 includes updating the optimization strategy and implementing it. However, if updates are not greater than a threshold at 422 or if updated optimization strategies are implemented at 424, then method 400 proceeds to 426. At 426, method 400 includes determining if target state-of-charge (SOC) and fuel level have been reached. If at 426, target state-of-charge (SOC) and fuel level have not been reached, then method 400 returns to 420 to continue implementing the optimal strategy while monitoring for updates. However, if at 426, target state-of-charge (SOC) and fuel level have been reached, then method 400 ends.

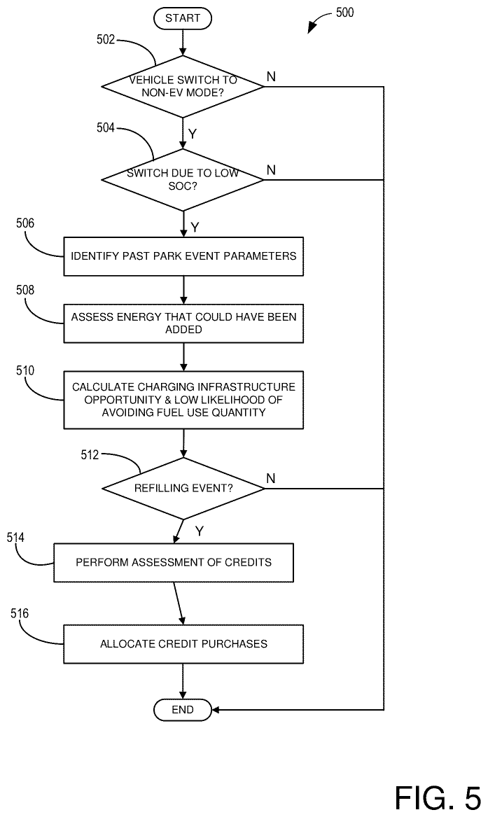

FIG. 5 shows an example method 500 for offsetting omissions which may comprise additional steps to those described in method 400. At 502, method 500 includes determining if a vehicle switches to non-EV mode. This may include determining if a vehicle's hybrid mode switches from consuming electricity in EV mode to consuming fuel, for example. If the vehicle switches to non-EV mode at 502, method 500 proceeds to 504. At 504, method 500 includes determining if the switch was due to a low SOC. If the switch was due to a low SOC at 504, method 500 proceeds to 506. At 506, method 500 includes identifying past park event parameters. For example, if the switch to non-EV driving is due to low high-voltage battery SOC, then the vehicle may identify past park event parameters such as SOC at a park event end, duration of the park event, availability of EV charging, etc. The method may also include determining if the driver simply did not plug the vehicle in; or if there was charging available but chargers were taken or out of service; or if a charge event was attempted and a fault occurred; or if there was no charging infrastructure.

At 508, method 500 includes assessing energy that could have been added. For example, given park event parameters and conclusions on EV charging potential, the vehicle may assess the energy that could have been added to the high voltage battery, relative to driving that occurred. At 510, method 500 includes calculating a charging infrastructure opportunity and low likelihood of not using fuel quantity. In some examples, this may include classify a charging infrastructure opportunity quantity and a low likelihood of not using fuel quantity.

At 512, method 500 includes determining if a refilling event occurs. If a refilling event occurs at 512, method 500 proceeds to 514. At 514, method 500 includes performing an assessment of credits. At 516, method 500 includes allocating credit purchases. For example, upon refilling, an LCFS-style assignment of credits may be made based on electricity and non-electric fuel consumed, and what may be implemented in the long-run to minimize upstream emissions. For example, for quantities of fuel consumed with a high charging infrastructure opportunity given the parking parameters, but where the EV charging infrastructure was unavailable (e.g., broken, chargers all occupied, charge fault, etc.), then credit purchases may be allocated to EV infrastructure investment and tied to those parking location(s). For quantities of fuel consumed with a low likelihood of not using fuel, credit purchases may be allocated to (potentially local/regional and possibly time-dependent) renewable fuel production. For quantities of electricity consumed, the credit purchases may be matched with (e.g., regional and time-based) renewable production opportunities. Such an approach may mean allocating credits to investment in on-site solar canopies for the charging station and/or parking lot, for example. Fuel and electricity quantities may be identified and used for non-motive purposes with a separate meter that transmits meter readings through the vehicle's network and telematics modem, for example.

FIG. 6 shows example utility factor curves that may be used to determine credit amounts attributable to PHEVs. In particular, FIG. 6 shows an EPA's MY27+ Light-Duty final ruling that depicts various utility factor curves that determine credit amounts attributable to PHEVs, and EPA's motivation for shifting the utility factor curve downward.

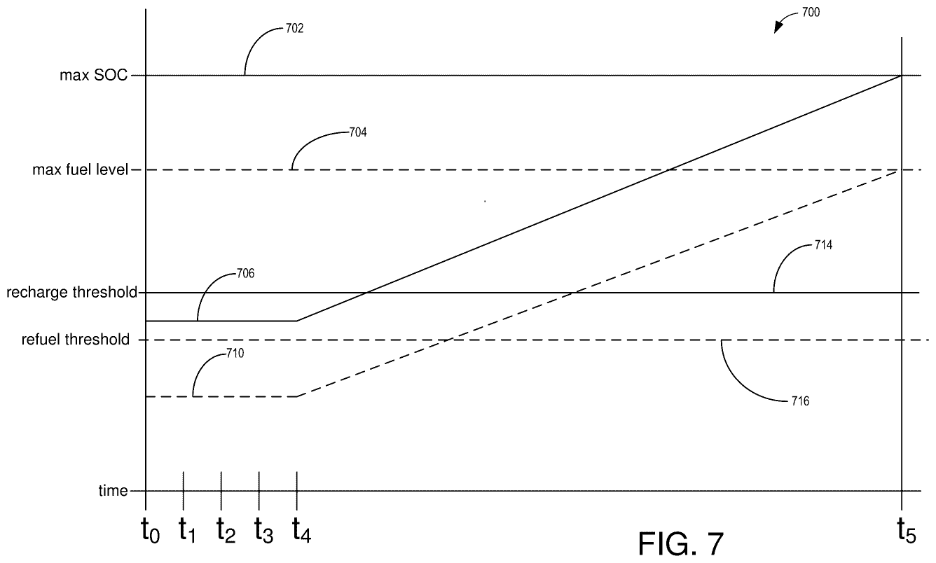

FIG. 7 shows an example time-line 700 of a vehicle refueling and recharging event. Different times t₀, t₁, t₂, t₃, t₄, and t₅ are shown along the horizontal axis in FIG. 7. Whereas different fuel and charge levels and thresholds are shown along the vertical axis in FIG. 7. In particular, FIG. 7 shows a gaseous fuel level curve 710 (dashed line) and a battery state-of-charge (SOC) curve 706 (solid line). These curves 710 and 706 may represent a gaseous fuel level in a storage tank onboard a vehicle and an SOC of a battery onboard the vehicle, respectively, where the vehicle comprises an PHEV, eREV or the like. FIG. 7 also shows a maximum battery SOC line 702, which represents a maximum SOC that the battery onboard the vehicle can obtain. FIG. 7 also shows a maximum fuel level line 704, which represents a maximum fuel level that can be stored in the onboard fuel tank in the vehicle. Also shown is a recharge threshold line 714, which may represent a threshold SOC of the onboard battery. If the SOC of the battery is less than or equal to recharge threshold 714, then a recharge of the battery may be implemented or scheduled. Likewise, a refuel threshold line 716 is shown, which may represent a threshold fuel level (e.g., represented as a pressure level) of gaseous fuel in the onboard gaseous fuel tank. If the gaseous fuel level in the onboard fuel tank is less than or equal to the refuel threshold 716, then a refill of the fuel tank may be implemented or scheduled.

At time t₀ in FIG. 7, a vehicle arrives at a station for refueling and/or recharging an onboard gaseous fuel tank and/or an onboard battery, respectively. At time t₀, as indicated by the fuel level curve 710, the fuel level is less than refuel threshold 716 thus a refuel is scheduled. Likewise, at time t₀, as indicated by the battery SOC curve 706, the SOC of the onboard battery is less than recharge threshold 714, thus a recharge is also scheduled or implemented. Additionally, at time t₀ a time window may be specified that represents a time duration that the vehicle is able to stay at the station for refueling and/or recharging. In this example, time t₅ represents a time that the vehicle is to leave the station, thus the time window is the time interval between t₀ and t₅.

At time t₁, the vehicle is put in communication with the station to obtain station parameters. For example, the system may attempt to obtain various station parameters either from an existing database or from communication with the station, for example via exchange between a telematics modem or other wireless protocol, and/or using vehicle sensors if the vehicle is on-site. Examples of fuel station parameters that may be obtained include: one or more of gaseous fuel pressure capacities available at the station; electric charging speeds available at the station; and station utilization information.

At time t₂, vehicle parameters are obtained. Examples of vehicle parameters that may be obtained include: a gaseous fuel level in the gaseous fuel tank. a pressure in the gaseous fuel tank, a vehicle ambient air temperature and/or a state-of-charge of the battery. At time t₃ an optimal refuel and recharging strategy may be calculated. For example, calculations may be performed to estimate refuel (gaseous fuel) and charge (electric charging) times to reach a target in the specified time window so that the fuel is refilled to the max level 704 (or some other target level) and the battery is charged to max SOC 702 (or some other target level) on or before the time window ends at t₅. For example, the calculations may determine how much to adjust refueling and charging rates. At t₃, data may also be obtained on opportunities to reduce resources and/or CO2 for charging and refueling and recharge and refuel rates adjusted based on that. This may include calculating a recommended strategy and updating vehicle parameters accordingly, such as requested charge current and voltage following an optimized charge curve, and requested gaseous fuel pressure following a gaseous fuel curve (such as the curves shown in FIG. 6).

At t₄, calculated optimal refuel and charging strategy may be implemented while monitoring for updates (e.g., updates to station utilization). For example, a charge rate of the battery and a refueling rate of the gaseous fuel tank may be adjusted based on vehicle parameters and fuel station parameters and fuel refilling and battery recharging may continue until the target fuel level (e.g., max fuel level 704) and target SOC of the battery (e.g., max SOC 702) are reached at time t₅. It should be understood that times t₀ through t₄ may correspond to approximately the same time in some examples; in other examples there may be differences in these times depending on the amount of time used to obtain parameters, perform the calculations and implement refueling and recharging strategies.

Note that the example control and method routines included herein can be used with various engine and/or vehicle system configurations. The control methods, routines, etc. disclosed herein may be stored as executable instructions in non-transitory memory and may be carried out by the control or manufacturing systems that include the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but is provided for ease of illustration and description. One or more of the illustrated actions, operations, and/or functions may be repeatedly performed depending on the particular strategy being used. Further, the described actions, operations, and/or functions may graphically represent code to be programmed into non-transitory memory of the computer readable storage medium in the system, where the described actions are carried out by executing the instructions in a system including the various hardware components in combination with the electronic controller.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A method for a vehicle comprising a battery and a gaseous fuel tank, the method comprising:
adjusting a charge rate of the battery and a refueling rate of the gaseous fuel tank based on vehicle parameters and fuel station parameters.

2. The method of claim 1, wherein the vehicle parameters comprise a gaseous fuel level in the gaseous fuel tank.

3. The method of claim 1, wherein the vehicle parameters comprise a pressure in the gaseous fuel tank.

4. The method of claim 1, wherein the vehicle parameters comprise a vehicle ambient air temperature.

5. The method of claim 1, wherein the vehicle parameters comprise a state-of-charge of the battery.

6. The method of claim 1, wherein the fuel station parameters comprise gaseous fuel pressure capacities available at the fuel station.

7. The method of claim 1, wherein the fuel station parameters comprise electric charging speeds available at the fuel station.

8. The method of claim 1, wherein the fuel station parameters comprise fuel station utilization information.

9. The method of claim 1, further comprising adjusting the charge rate of the battery and the refueling rate of the gaseous fuel tank based on a target gaseous fuel level and a target battery state-of-charge.

10. The method of claim 1, further comprising adjusting the charge rate of the battery and the refueling rate of the gaseous fuel tank based on a time window to charge and refuel.

11. The method of claim 1, wherein adjusting the charge rate of the battery comprises charging the battery at a rate less than what is available from an electric charger at the fuel station.

12. The method of claim 1, wherein adjusting the charge rate of the battery comprises increasing a charging rate of the battery.

13. The method of claim 1, wherein the vehicle comprises a plug-in hybrid electric vehicle or an extended-range electric vehicle.

14. The method of claim 1, wherein the gaseous fuel tank comprises a compressed natural gas fuel tank.

15. The method of claim 1, wherein the gaseous fuel tank comprises a hydrogen fuel tank.

16. The method of claim 1, further comprising monitoring fuel station capacity utilization and updating the charge rate of the battery and the refueling rate of the gaseous fuel tank in response to a change in fuel station capacity utilization.

17. A method for a vehicle comprising a battery and a gaseous fuel tank, the method comprising:
adjusting a charge rate of the battery and a refueling rate of the gaseous fuel tank based on vehicle parameters and fuel station parameters;
wherein the vehicle parameters comprise a pressure in the gaseous fuel tank, a vehicle ambient air temperature, and a state-of-charge of the battery; and
wherein the fuel station parameters comprise gaseous fuel pressure capacities available at the fuel station, electric charging speeds available at the fuel station, and fuel station utilization information.

18. The method of claim 1, further comprising adjusting the charge rate of the battery and the refueling rate of the gaseous fuel tank based on a target gaseous fuel level, a target battery state-of-charge, and a time window to charge and refuel.

19. A method for a vehicle comprising an electric traction battery and a gaseous fuel tank, the method comprising:
adjusting a charge rate of the battery and a refueling rate of the gaseous fuel tank based on vehicle parameters, fuel station parameters, and target parameters;
wherein the vehicle parameters comprise a pressure in the gaseous fuel tank, a vehicle ambient air temperature, and a state-of-charge of the battery; and
wherein the fuel station parameters comprise gaseous fuel pressure capacities available at the fuel station, electric charging speeds available at the fuel station, and fuel station utilization information; and
wherein the target parameters comprise a target gaseous fuel level, a target battery state-of-charge, and a time window to charge and refuel.

20. The method of claim 19, wherein the gaseous fuel tank comprises a compressed natural gas fuel tank or a hydrogen fuel tank.
